(19) United States
(12) Patent Application Publication
(10) Pub. No.: US 2007/0022283 A1
(43) Pub. Date: Jan. 25, 2007

(54) Method for fast activation of computer from a data disk with pre-installed operating system

(76) Inventor: Sheng-Kai Hsu, Luodong Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/247,383

(22) Filed: Oct. 12, 2005

(30) Foreign Application Priority Data
Jul. 22, 2005 (TW) 94125016

(51) Int. Cl. G06F 9/24

(52) U.S. Cl. 713/2

(57) ABSTRACT

A method for fast activation and playing of multimedia data from a data disk with pre-installed operating system is provided. A boot sector of the data disk is pre-installed with a selected operating system for activating the computer. The data disk also stores a multimedia playing application program and multimedia data. When the computer is turned on, the computer uses the data disk as an activation device, and loads and executes the operating system in the data disk. Then, the computer executes the multimedia playing application program to read the multimedia data in the data disk. The system memory of the computer is configured with a random access memory region for the space required for executing the operating system and the multimedia playing application program.

### FIELD OF THE INVENTION

The present invention relates to a method for activation of computer system and, more particularly, to a method for fast activation with a data disk with pre-installed operating system.

### BACKGROUND OF THE INVENTION

Generally, a computer is equipped with a multimedia player for playing of multimedia data. Multimedia data is stored in specific multimedia data format. Currently, there are a variety of multimedia data formats, which are executable by corresponding multimedia playing application programs. By activating the multimedia playing application program, a user can play the multimedia data in the computer.

Whenever a user wants to play multimedia data or to execute any application programs, the user has to boot up the computer first. Even if the user wants to play multimedia data only, he has to activate the multimedia playing application program via the computer operating system. In other words, the user turns on the computer which goes through a series of activation processes including initializing the basic input/output system (BIOS), completing power-on-self-test (POST) program, detecting and driving the peripheral devices, executing the operating system, setting the system configurations and so on. The user has to wait for the activation processes before he can execute the multimedia playing application program to play to multimedia data. This is inconvenient to the user as there is no shortcut to bypass the tedious booting process of the computer system.

Take for an example. For graphics or images in the forms of Joint Photographic Experts Group (JPEG), Graphics Interchange Format (GIF) or Tag Image File Format (TIFF), which are recorded on a CD or a DVD, the user can view the graphics or images by a computer which has been pre-installed with an operating system and appropriate application programs like ACDsee, Photoshop.

After use, the computer is orderly closed-down. If the user directly turn off the power, the hard disk and the storage data in the computer may be damaged.

The browsing of graphics depends on not only the application programs, but also the operating system of the computer. If the graphics are recorded in a format that is not executable for the computer operating system, the graphics cannot be read and browsed.

Some improvements have been developed to overcome the aforementioned inconvenience. The majority of the proposed solutions includes a mechanism to format a first partition area and a second partition area in the hard disk of the computer. The first partition area stores a first operating system (such as Linux-based OS), and the second partition area stores a second operating system (such as Microsoft Windows). The BIOS system of the computer is also modified correspondingly. With such improvements in place, the user can use a switch or a remote control to determine whether to activate the system in PC mode or AV mode. In the latter case, when the computer is activated, the computer does not execute the general activation process. Instead, the computer loads and executes the first operating system in the first partition area, driving only the necessary audiovisual device, and selecting the appropriate playing function to play, such as DVD. In other words, the user does not require to enter the Windows operating system, and the tedious initialization and activation of other hardware of the computer system can be avoided.

However, the aforementioned solution, although able to fast activate and play multimedia data, requires a specific formation of the hard disk to include a partition area to store a different operating system and a plurality of multimedia application programs. In addition, it is also necessary to modify the BIOS system of the computer, which complicates the hard disk formatting and the modified BIOS system can only be used for specific devices and products, instead of other computers.

Furthermore, the aforementioned solution requires formatting a separate partition area in the hard disk to store programs and information for activation applications. The partition area cannot be accessed or modified by the user. This not only wastes storage space in the hard disk, but also limits the use of the hard disk.

It is, therefore, imperative to develop a method for fast activation and playing of multimedia data without the complication and constrain of the conventional solution.

### SUMMARY OF THE INVENTION

The present invention is aimed to overcome the aforementioned drawbacks of the conventional solution. A primary objective of the present invention is to provide a method for fast activation and playing multimedia data from a data disk with pre-installed operating system for solving the problem that a specific reformatting of the hard disk and modification of BIOS system are not applicable to general computers.

Another objective of the present invention is to provide a method for fast activation and playing of multimedia data without activating a general operating system to save the time for tedious activation and initialization incurred in operation system activation.

Yet another objective of the present invention is to provide a method for fast and easy activation of computer, that does not require the modification of BIOS system. It enables the computer to execute a specific application program and immediately browse the multimedia data recorded in the data disk.

A further objective of the present invention is to provide a method of fast activation of computer with from a disk with pre-installed operating system. When the computer is activated, it is not required for the computer to execute the general operating system or to detect and driving the peripheral devices. It avoids the problem of crashing of computer or damage to the storage data in the hard disk caused by the abnormal functioning of peripheral devices.

The present invention achieves the objectives by providing a data disk, such as compact disk, to be used in activating the computer. A boot sector of the data disk is pre-installed with an operating system for activating the computer. The data disk also stores a multimedia playing application program and at least one multimedia data. When the computer is turned on, the computer uses the data disk as an activation device, and loads and executes the operating system in the data disk. Then, the computer executes the multimedia playing application program to browse the multimedia data in the data disk. In a preferred embodiment, the system memory of the computer is configured with a random access memory region for the space required for executing the operating system and the multimedia playing application program.

The present invention, in comparison with the conventional techniques, neither requires to modify the BIOS system nor formatting a specific area in the hard disk drive. The present invention requires only a data disk pre-installed with an operating system and multimedia playing application program to achieve the fast activation and playing of the multimedia data. It allows the user to rapidly browse the multimedia data and efficiently saves time by simplifying the activation processes.

Besides, to boot the computer, only the basic and simple activation processes is executed only. It is not necessary to load the association programs and/or driving programs for peripheral devices. The operating system and multimedia playing application program occupy only small spaces of the data disk. Therefore, it allows the data disk to have more space for recording other data.

Also, the computer uses the data disk to operate and the hard disk of the computer is not used. Even if there is power failure or vibration, the hard disk is not damaged.

The data disk can record any selected operating system different from the operating system of the computer. Hence, the data disk can be used for different computers and for reading of multimedia data in different multimedia data formats.

The operation procedures are very simple. To browse the multimedia data, the user only has to insert the data disk to the computer and turn on the computer.

These and other objects, features, and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 is a schematic view of a computer system of the present invention;

FIG. 2 is a schematic view of a data disk with a pre-installed operating system, a configuration setting parameter file, a program execution batch file, a multimedia playing application program and a multimedia data file; and

FIG. 3 and FIG. 4 show control flowcharts of the present invention.

### DETAILED DESCRIPTION OF THE PREFERRED EMBODIMENTS

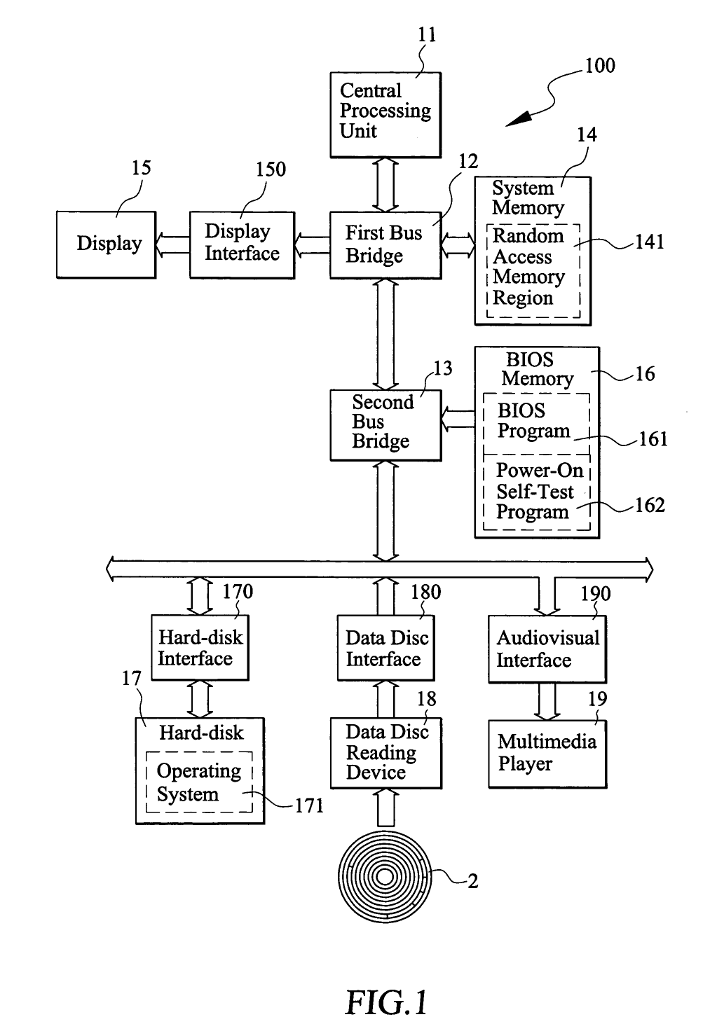

With reference to the drawings and in particular to FIG. 1, which shows a schematic view of a computer system with a method for fast activation and playing of multimedia data according to the present invention, a computer 100 includes a central processing unit 11, a first bus bridge 12, a second bus bridge 13, a system memory 14 and a display 15. The central processing unit 11 is connected to the first bus bridge 12 through a system bus. The first bus bridge 12 is connected to the system memory 14 and connected to a display 15 through a display interface 150.

The second bus bridge 13 is connected to a basic input/output system memory 16 (BIOS memory). The BIOS memory 16 stores a BIOS program 161 and a power-on-self-test (POST) program 162, required by computer 100 during booting.

The second bus bridge 13 is connected to a hard-disk interface 170 through a bus. The hard-disk interface 170 is connected to a hard disk 17. The hard disk 17 served as a data storage device is for storing data in the present invention. The hard disk 17 is installed with an operating system 171 and other device drivers and application programs working under the operating system environment

The second bus bridge 13 is connected to a data disc interface 180 via a bus. The data disk interface 180 is connected to a data disk reading device 18. The data disc reading device 18 is capable to read a data disk such as compact disc or DVD.

The second bus bridge 13 is connected to a multimedia player 19 through an audiovisual interface 190. The multimedia player 19 can be a DVD player, MP3 player, CD player, or TV receiver.

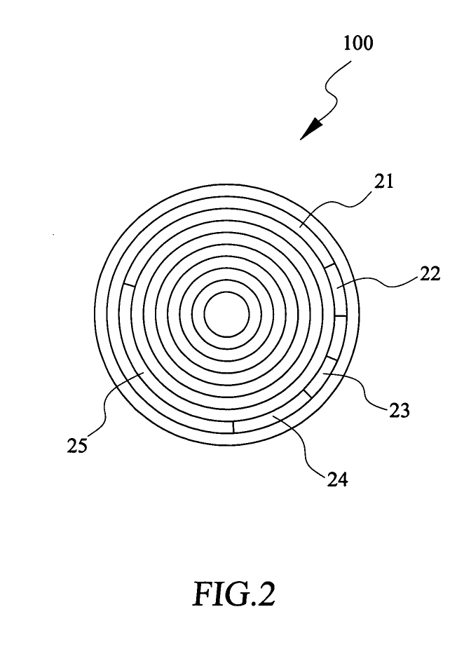

FIG. 2 shows a schematic view of a data disk with a pre-installed operating system, a configuration setting parameter file, a program execution batch file, a multimedia playing application program and at least one multimedia data file. As shown in FIG. 2, a data disk 2 is pre-installed with an operating system 21 at a boot sector thereof. The operating system may be Linux-based operating system or other types of operation system, such as Tiny Windows-based operating system, or embedded operating system.

The data disk 2 also stores a pre-set configuration setting parameter file 22, a program execution batch file 23, a multimedia playing application program 24 and at least one multimedia data file 25. The program execution batch file 23 is pre-set with settings for executing the multimedia playing application program 24.

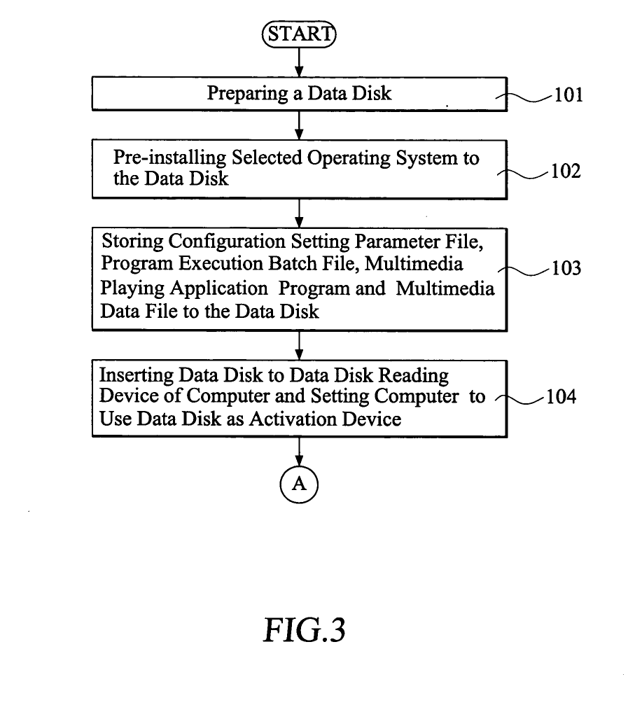

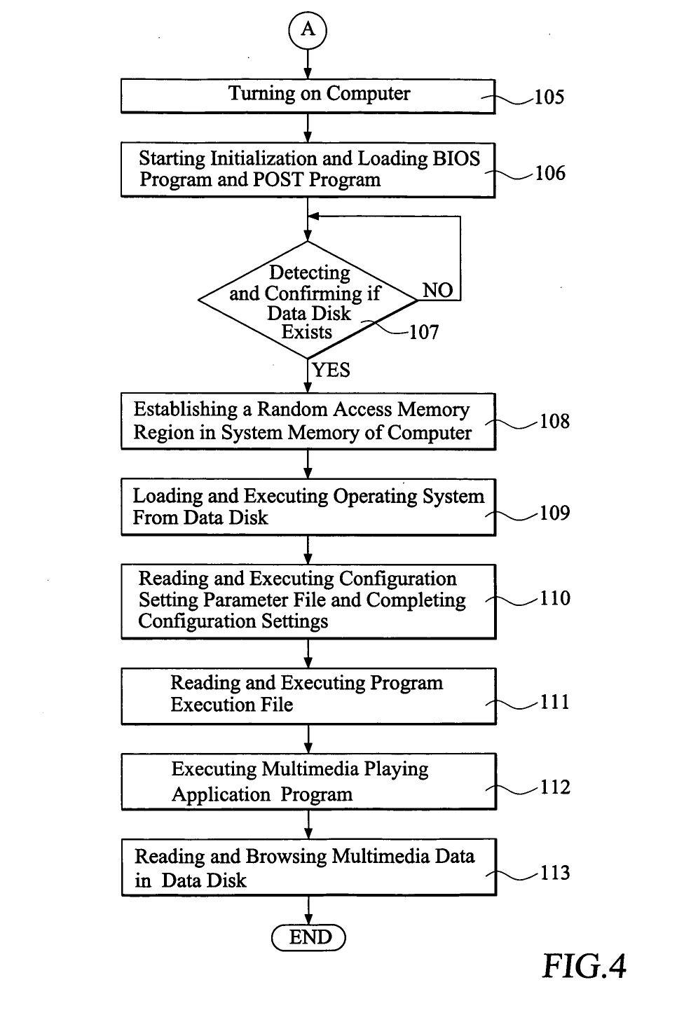

FIG. 3 and FIG. 4 show a flowchart of a control flowchart of the present invention. The following explanation refers to both FIGS. 1 and 2.

Firstly, a data disk 2 is prepared in step 101. The data disk 2 is pre-installed with a selected operating system 21 in step 102 at the boot sector thereof. In step 103, a configuration setting parameter file 22, a program execution batch file 23, at least one multimedia playing application program 24 and at least one multimedia data file 25 are stored to the data disk 2.

The data disk 2 is inserted to the data disk reading device 18 of the computer 100 and the computer 100 is set to use the data disk 2 as its activation device in step 104.

The computer 100 is turned on in step 105. The computer 100 proceeds the basic activation processes in step 106. The computer 100 starts the initialization and loads the BIOS program 161 and the POST program 162 from BIOS memory 16.

After the computer 100 finishes the initialization and POST program, the computer 100 executes step 107 to detect and confirm if the data disk 2 exists. If the data disk 2 exists, the computer 100 uses the data disk 2 as the activation device. In other words, the computer 100 is booted by the data disk 2; otherwise, the computer 100 is activated by the operating system 171 of the hard disk 17. This activation determination step is usually controlled by the BIOS function table of the computer 100. For example, the user sets the data disk 2 as the first priority activation device and the hard disk 17 as the second priority activation device in the BIOS function table. When the computer 100 is activated, if the data disk 2 is detected in the disk reading device 18, the computer 100 chooses the data disk 2 as the activation device.

Step 108 is to establish a random access memory region 141 in the system memory 14 of the computer 100 for the space required for executing the operating system and the multimedia playing application program. When the computer 100 uses the operating system 21 in the data disk 2 to operate, the computer 100 loads the operating system 21 at the boot sector to the random access memory region 141 of the system memory 14, and executes the operating system 21 (step 109).

Subsequently, the computer 100 reads and executes the configuration setting parameter file 22 and completes the configuration setting (step 110).

In step 111, the computer 100 reads and executes the program execution batch file 23 so that the pre-set programs in the program execution batch file 23 are orderly executed. Then, the computer 100 directly executes the multimedia playing application program 24 in the data disk 2 in step 112, and reads the multimedia data file 25 to browse the multimedia data stored in the data disk 2 in step 113.

In the preferred embodiment of the present invention, the multimedia playing application program 24 is a graphics reading program and the multimedia data file 25 is a graphics file. After the multimedia playing application program 24 are executed and the multimedia data file 25 is read, the graphics in the data disk 2 can be browsed or displayed.

In summary, the method for fast activation and playing of multimedia data by a data disk with pre-installed operating system in accordance with the present invention can achieve the above mentioned objectives. It is not required to modify the BIOS system of the computer. The computer can operate rapidly to activate a specific application program so that the graphics or multimedia data stored in the data disk can be read, browsed, or displayed. It allows the user to rapidly fetch the multimedia data and efficiently saves time by simplifying the activation processes. It is not necessary to load the association programs and/or device driver for peripheral devices of the computer system. The operating system and multimedia playing application program occupy only small spaces of the data disk. Therefore, it allows the data disk to have more space for recording other data. Also, the computer is booted by the operating system pre-installed in the data disk, not by the original operating system of the computer, so that the multimedia data playing operation is not influenced by the failure of the original operating system of the computer.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. A method of playing multimedia data from a data disk for a computer comprising a data disk reading device, the data disk being pre-installed with an operating system, a multimedia playing application program, at least one multimedia data and a configuration setting parameter file, the method comprising steps of:
(a) turning on the computer;
(b) using the data disk as an activation device to booting the computer;
(c) loading and executing the operating system of the data disk into the computer;
(d) executing the configuration setting parameter file to complete a configuration setting of the computer; and
(e) executing the multimedia playing application program and reading the multimedia data in the data disk.

2. The method as claimed in claim 1, wherein the data disk further comprises a program execution batch file which is pre-set with settings for executing the multimedia playing application program, and thereby when the computer executes the program execution batch file, the computer executes the multimedia playing application program.

3. The method as claimed in claim 1, wherein the multimedia playing application program is a graphics reading program and the multimedia data in the data disk is graphics data.

4. The method as claimed in claim 1, further comprising a step of setting the computer to use the data disk as the operating system activation device of the computer prior to step (a).

5. The method as claimed in claim 1, further comprising a step of establishing a random access memory region in a system memory of the computer for the space required for executing the operating system and the multimedia playing application program after step (b).

6. The method as claimed in claim 5, further comprising a step of detecting and confirming whether the data disk exists prior to step (c).
